(19) United States
(12) Patent Application Publication
(10) Pub. No.: US 2025/0024395 A1
(43) Pub. Date: Jan. 16, 2025

(54) APPARATUS AND METHOD OF AUXILIARY REPORTING FOR NETWORK VERIFIED USER EQUIPMENT LOCATION FOR NON-TERRESTRIAL NETWORKS

(71) Applicant: Samsung Electronics Co., Ltd., Gyeonggi-do (KR)

(72) Inventors: Seyed Mohsen HOSSEINIAN, San Diego, CA (US); Philippe Jean Marc Michel SARTORI, Naperville, IL (US)

(21) Appl. No.: 18/765,776

(22) Filed: Jul. 8, 2024

Related U.S. Application Data
(60) Provisional application No. 63/512,772, filed on Jul. 10, 2023.

(51) Int. Cl. H04W 56/00; H04W 84/06

(52) U.S. Cl. CPC H04W 56/0065; H04W 56/0015; H04W 56/005; H04W 84/06

(57) ABSTRACT

A system and a method are disclosed for UE operations in an NTN. A method performed by a UE includes receiving, from a base station, a PRS in a DL subframe; determining a timestamp or subframe indices of the PRS in the DL subframe and a timestamp or subframe indices of a UE UL subframe that is closest in time to the DL subframe; determining, based on the timestamps or the subframe indices, a UE time difference from receiving the PRS to a transmission of an SRS; generating an auxiliary report including adjustment information for an LMF to calculate the UE time difference; providing the auxiliary report to the LMF; and reporting, to the LMF, the SRS based on the UE time difference.

### CROSS-REFERENCE TO RELATED APPLICATION

This application claims the priority benefit under 35 U.S.C. § 119 (e) of U.S. Provisional Application No. 63/512,772, filed on Jul. 10, 2023, the disclosure of which is incorporated by reference in its entirety as if fully set forth herein.

### TECHNICAL FIELD

The disclosure generally relates to improving wireless communication for non-terrestrial networks (NTNs). More particularly, the subject matter disclosed herein relates to improvements to multi-round trip time (multi-RTT) techniques such that user equipment (UE) location may be verified by measurements performed by one satellite.

### SUMMARY

According to 3rd Generation Partnership Project (3GPP) Release 18 (Rel-18) for NTN, a predefined level of precision for determining a user equipment (UE) location should be provided in order to use certain services, including public warning systems (PWS), lawful interception (LI) systems, emergency services (EMS), and charging and tariff notifications.

Depending on global navigation satellite systems (GNSS) for pinpointing location presents challenges due to signal weakness in certain positions or the possibility of data tampering. For example, in some regions and locations a GNSS signal may be very weak and below required noise margin. Consequently, a reported UE location determined by its GNSS receiver may not be sufficiently accurate.

As another issue, UE location information may be maliciously tampered with by the UE itself or by a 3rd party.

These type of issues underscore the necessity for a UE location verification method by a network that does not necessarily rely on GNSS data.

Among available location verification methods, a multi-RTT method has been chosen for network verified UE location in NTN. The multi-RTT method that is being considered for NTN is based on transmitting positioning reference signals (PRSs) from a base station (e.g., a gNB) to the UE, and transmitting sounding reference signals (SRSs) from the UE to the gNB. Based on these operations, the gNB measures and reports gNB reception (Rx)-transmission (Tx) time difference to a location management function (LMF). Similarly, the UE measures and reports a UE Rx-Tx time difference separately to the LMF. Thereafter, the LMF calculates an RTT. This operation is generally repeated multiple times.

However, this type of method may have limitations in NTN scenarios, especially with low earth orbit (LEO) satellites, where a velocity of a satellite significantly impacts timing of downlink (DL) and uplink (UL) subframes.

Therefore, compared to terrestrial networks, a need exists for improvements to measuring and reporting details to support a multi-RTT method for an NTN.

To overcome the above-described types of issues, the present disclosure provides systems and methods for improving UE Rx-Tx and gNB Rx-Tx time differences for a multi-RTT method applicable in an NTN.

In the disclosure, operations are provided for reporting auxiliary information, such as Doppler frequency, from a UE to an LMF, in order to provide an enhanced multi-RTT method for a single satellite, network verified UE location in an NTN.

For example, a UE may report, to an LMF, a difference between the Doppler frequency measured when receiving a PRS (or a channel state information reference signal (CSI-RS)) in DL subframe #i (or UL subframe #j) and the Doppler frequency measured when transmitting an SRS in UL subframe #k. The UE may simply calculate the Doppler frequency at DL subframe #i, when it receives PRS (or CSI-RS) and also at UL subframe #k when it transmits SRS, and the difference between the two values may be reported to the LMF. The reported value may be positive or negative, depending whether the Doppler is increasing or decreasing during which PRS is received and SRS is sent.

The UE may also report UE Rx-Tx and an offset value.

The UE may also report the Doppler frequency measured at DL subframe #i or at uplink subframe #k, separately, to the LMF.

Accordingly, embodiments of the present disclosure significantly improve the reliability of UE location verification in NTN environments, addressing the challenges posed by such settings, including the mobility of satellites. The present disclosure offers a robust framework for UE location verification that surpasses previous methods by providing enhanced accuracy for critical services without reliance on GNSS data. Moreover, UE location verification can be achieved using one satellite, and not relying on multiple transmission and reception points (TRPs) on the network.

According to an embodiment, a method is provided for a UE in an NTN. The method includes receiving, from a base station, a PRS in a DL subframe; determining a timestamp or subframe indices of the PRS in the DL subframe and a timestamp or subframe indices of a UE UL subframe that is closest in time to the DL subframe; determining, based on the timestamps or the subframe indices, a UE time difference from receiving the PRS to a transmission of an SRS; generating an auxiliary report including adjustment information for an LMF to calculate the UE time difference; providing the auxiliary report to the LMF; and reporting, to the LMF, the SRS based on the UE time difference.

According to an embodiment, a UE is provided for use in an NTN. The UE includes at least one processor; and memory that stores instructions, which when executed by the at least one processor, controls the UE to receive, from a base station, a PRS in a DL subframe, determine a timestamp or subframe indices of the PRS in the DL subframe and a timestamp or subframe indices of a UE UL subframe that is closest in time to the DL subframe, determine, based on the timestamps or the subframe indices, a UE time difference from receiving the PRS to a transmission of an SRS, generate an auxiliary report including adjustment information for an LMF to calculate the UE time difference, provide the auxiliary report to the LMF, and report, to the LMF, the SRS based on the UE time difference.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an NTN network environment, according to an embodiment;

FIG. 2 illustrates a network signaling operation for performing an RTT measurement, according to an embodiment;

FIG. 3 is a chart depicting DL subframe variation over time, according to an embodiment;

FIG. 4 illustrates a DL subframe length as observed by a UE when a satellite in an LEO-600 NTN scenario passes overhead, according to an embodiment;

FIG. 5 is a chart depicting UL subframe variation over time, according to an embodiment.

FIG. 6 illustrates a timing diagram comparing gNB DL and UL subframes to UE DL and UL subframes, according to an embodiment;

FIG. 7 illustrates a UE Rx-Tx time difference, according to an embodiment;

FIG. 8 illustrates a gNB Rx-Tx time difference, according to an embodiment;

FIG. 9 illustrates an example of UE reporting using predicted Doppler, according to an embodiment;

FIG. 10 is a flowchart illustrating a method performed by a UE in an NTN environment, according to an embodiment;

FIG. 11 is a block diagram of an electronic device in a network environment, according to an embodiment; and

FIG. 12 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

In 3GPP new radio (NR), when a UE attaches to a mobile network, a radio access network (RAN) selects an appropriate core network (CN) for the UE. To do so, the RAN takes into account UE attributes, such a UE identifier (ID), a UE's selected public land mobile network (PLMN), and/or a UE's location information (including a serving cell as known to the serving RAN node).

An NTN often deploys very large cells over a large section of area, which may cover two or even more different countries. In such cases, there may be different CNs for belonging to two or more countries connected to the same NTN RAN (e.g., a multi-operator CN (MOCN) sharing scenario). In such cases, it may not be possible to determine the appropriate CN for a connecting UE, especially if the UE is near the country borders, since the serving cell information may not be granular and/or accurate enough.

There is also the risk of malicious UEs fraudulently altering their selected PLMN to connect to a different CN.

Upon such a malicious attempt, an access and mobility management function (AMF) is expected to disconnect the UE and inform the RAN node, via an appropriate next generation application protocol (NGAP) value, such that the RAN can take appropriate measures on subsequent connection attempts by the same UE.

While the UE may send GNSS measurements to the RAN over radio resource control (RRC) for a network to verify the UE location, this method also has drawbacks.

For example, similar to the same way that a malicious UE could falsify its selected PLMN, a malicious UE could also falsify its GNSS measurements. Further, sending GNSS measurements to the RAN over RRC, before non-access stratum (NAS) security is set up, raises serious privacy and security issues. Additionally, even after establishment of NAS security, depending on regional regulation and policy, user consent for obtaining UE location information might also be required.

However, regardless of the types of issues described above, at least some information that a UE supplies to a network should be considered as trusted. Otherwise, it will be practically impossible to verify the UE location in a trustworthy manner.

Determining a UE's location may be necessary in a 5th generation (5G) NR system with NTN satellite access to support services such as routing traffic and supporting emergency calls, in accordance with the national or regional regulatory requirements applicable to the UE.

Network operators supporting NTN should accurately know a UE's location in order to select an appropriate CN for the UE, enabling support for services subject to national regulations or other operational constraints. For example, the NTN Rel-18 framework has identified services that require accurate location information: PWS, LI, EMS, and charging and tariff notifications

However, as described above, the location information reported by a UE (e.g., determined with a GNSS receiver) may be erroneous either intentionally (e.g., maliciously tampering by a user or by a 3rd party) or unintentionally (e.g., due to interference), and therefore, according to the Rel-18 NTN work item, the location information reported by a UE cannot be considered trusted by network operators.

Although 3GPP has defined a network-based functionality to verify a reported UE location with an identifier of a serving cell (e.g., a cell ID) for terrestrial networks, radio cells in cellular NTNs are typically much larger than those of cellular terrestrial networks and may cover borders between two or more countries. Therefore, this type of cell ID information may not be sufficient to discriminate the country in which the UE is located.

Accordingly, the present disclosure provides improved multi-RTT methods to satisfy NTN requirements.

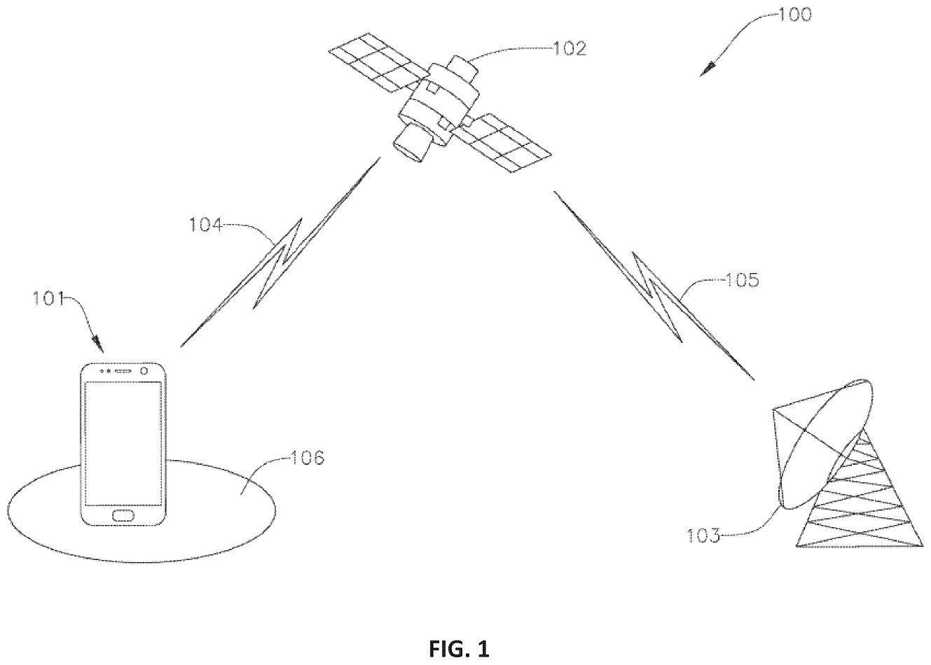

FIG. 1 is a diagram illustrating an NTN network environment, according to an embodiment.

Referring to FIG. 1, a network 100 may be a multiple access wireless communication system that supports a broadcast service, such as an NTN. The network 100 may be designed to support one or more standards, such as 3GPP. The network 100 includes a UE 101, a satellite 102, and a gNB 103.

The UE 101 may be able to transmit, receive, store, and process data. The UE 101 may be an electronic device including a transceiver system such as a mobile device, laptop, or other equipment.

The satellite 102 may be an orbiting platform capable of sending and receiving data from the UE 101 and the gNB 103. The satellite 102 may be in communication with the UE 101, where the satellite 102 may be able to transmit and receive data from the UE 101 over a communication link 104. The communication link 104 may include UL and DL data transmissions.

The gNB 103 may include an antenna capable of sending and receiving data from the satellite 102. The gNB 103 may be connected to or associated with a base station or logical radio node. The gNB 103 may be in communication with the satellite 102 over a communication link 105. The communication link 105 may include UL and DL data transmissions.

The cell 106 may be a geographic area where the UE 101 and other UEs are capable of communicating with the satellite 102. The size of the cell 106 may vary depending on the location of the satellite 102 relative to Earth. For example, geostationary equatorial orbit (GEO) satellites may allow for a larger cell 106 area, which may be between 200 kilometers (km) to 3,500 km in diameter, in one embodiment. Medium earth orbit (MEO) and LEO may have smaller associated cell 106 sizes. Furthermore, the distance from the satellite 102 to Earth may affect the transmission time of transmitting and receiving data between the UE 101 and the satellite 102, and between the satellite 102 and the gateway 103.

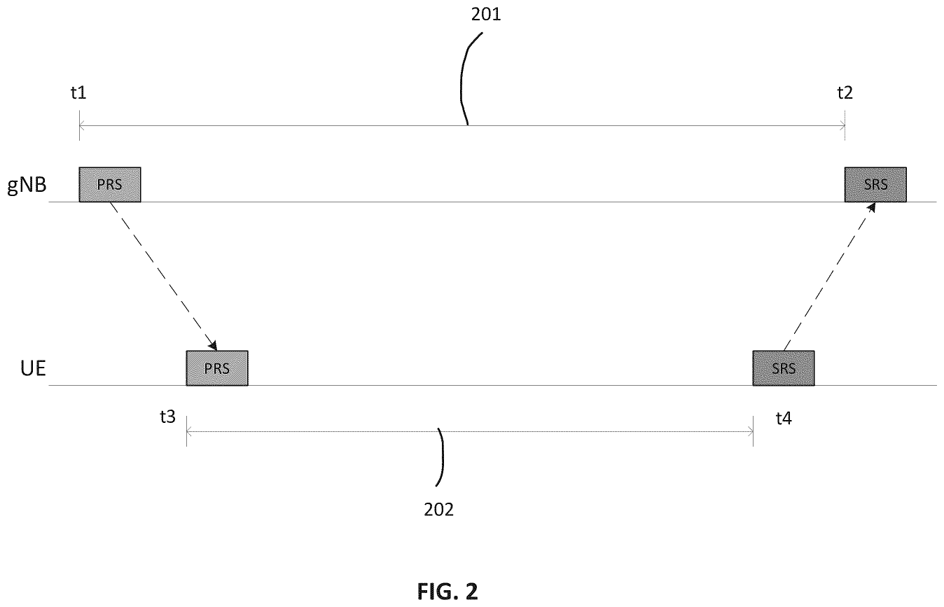

FIG. 2 illustrates a network signaling operation for performing an RTT measurement, according to an embodiment.

Referring to FIG. 2, a gNB and a UE are shown. The gNB and UE may correspond to gNB 103 and UE 101, respectively.

A multi-RTT method for an NTN may be based on transmitting a PRS from the gNB to the UE, and transmitting an SRS from the UE to the gNB. Based on these operations, the gNB and the UE make measurements and report the measurements to an LMF. The LMF may calculate RTT according to Equation (1), below:

$$RTT = ( t 2 - t 1 ) + ( t 3 - t 4 ) \qquad ( 1 )$$

In order for the LMF to calculate (t2−t1), the gNB reports a gNB Rx-Tx time difference to the LMF, marked as 201 in FIG. 2. Similarly, in order for the LMF to calculate (t3−t4), the UE reports a UE Rx-Tx time difference to the LMF, marked as 202 in FIG. 2.

In the context of mobile telecommunications, particularly within 3GPP standards for 5G networks, the LMF is a functional entity responsible for managing the location of the UE and services provided to the UE. The LMF may be used to determine the position of the UE based on various inputs and measurements, such as those from the RAN and other location measurement units. The LMF processes information to estimate and report the UE's location, supporting various applications and services that require precise location information, including EMS, location-based services, and network management tasks.

The LMF may reside in the CN of the 5G system, interfacing with other CN functions such as the AMF and a unified data management (UDM) function. The LMF may be hosted in a storage device on a network node, such as a gNB, UE, satellite, server, or another electronic device. The LMF may also interface with the RAN to obtain measurements and information from the network nodes to perform its location calculations

In the case of NTN environments operating using LEO satellites, the dynamic nature of LEO satellite movement introduces significant challenges for communication protocols, particularly in terms of timing and signal processing. For example, in an LEO-600 scenario, where the satellite orbits approximately 600 km above Earth's surface, the satellite may move at a relatively fast speed of 7.56 km per second. However, this rapid movement may have a pronounced effect on DL subframes received by the UE from the gNB, leading to variations in the perceived duration of these subframes due to the Doppler effect. For example, at such a high speed, due to the Doppler effect, when the satellite gets closer to or gets farther from a UE, DL subframes transmitted by a gNB are received at the UE with different subframe lengths than the transmitted subframe lengths. In other words, DL subframes shrink or expand from the UE's point of view.

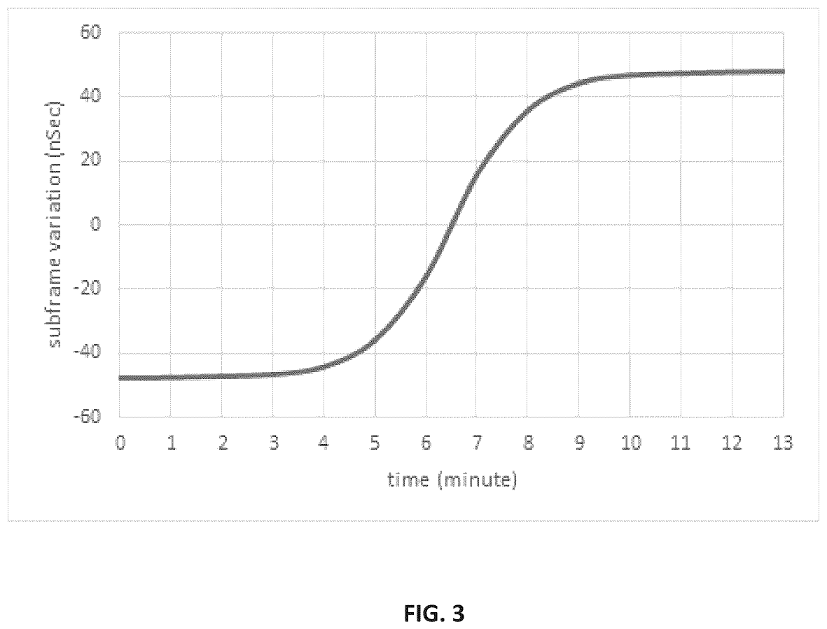

FIG. 3 is a chart depicting DL subframe variation over time, according to an embodiment.

Referring to FIG. 3, an amount of DL subframe shrinkage or expansion is shown from the perspective of the UE, as a satellite gets closer to or further from the UE in a transparent payload.

FIG. 3 assumes the UE is located within the LEO-600 satellite's orbital plane. Accordingly, the satellite remains in view of the UE for about 13 minutes during its orbit for the LEO-600 satellite orbital plane. During this period, the relative velocity between the satellite and the UE causes the DL subframe durations to vary. Specifically, as the satellite approaches the UE, the DL subframes, as observed by the UE, appear to contract, being shorter than the standard 1 millisecond (ms) duration by up to 48 nanoseconds (ns). This effect is most pronounced when the satellite is directly overhead, at which point the DL subframe duration approaches the nominal value of nearly 1 ms. Further, as the satellite moves away from the UE, the observed DL subframe durations expand, exceeding the standard duration by approximately 48 ns.

This variation in DL subframe duration poses a unique challenge for accurately determining the timing and hence the location of the UE. Methods for timing and location estimation, designed for relatively static terrestrial network environments, may not be directly applicable in the highly dynamic NTN context (since the DL subframe variations are more pronounced in the LEO NTN environment).

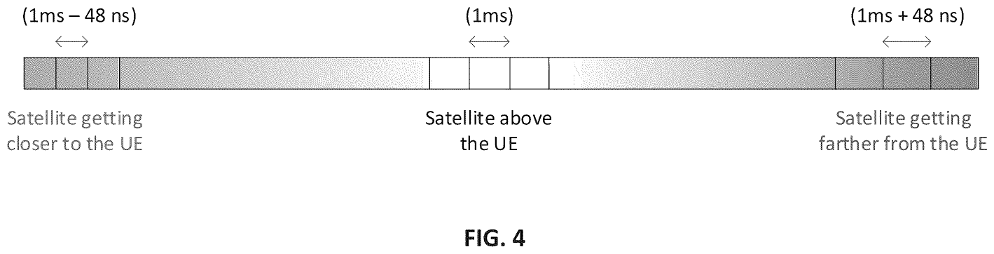

FIG. 4 illustrates a DL subframe length as observed by a UE when a satellite in an LEO-600 NTN scenario passes overhead, according to an embodiment.

Referring to FIG. 4, this depiction helps to visualize the Doppler effect on signal timing where the length of DL subframes contracts as the satellite approaches the UE and expands as it recedes. Specifically, when a satellite is getting closer to the UE, then the DL subframe may be approximately 1 ms-48 ns. This corresponds to the interval of 0 minutes to ˜3.5 minutes in FIG. 3. On the other hand, when the satellite is getting farther from the UE, then the DL subframe may be approximately 1 ms+48 ns. This corresponds to the interval of ˜9.5 minutes to 13 minutes in FIG. 3. Furthermore, when the satellite is above the UE, then the Doppler effect is least pronounced, and the DL subframe may be ˜1 ms. This corresponds to ˜6.5 minutes in FIG. 3.

The measurement of the UE's Rx-Tx time difference is a process that typically spans tens of subframes. Due to the speed of the satellite, the cumulative measurement error in the DL subframe length after, e.g., 20 subframes, could approach nearly 1 us. If a method for measuring the UE Rx-Tx time difference relies solely on counting the number of DL subframes and presumes a constant subframe length, it may result in significant inaccuracies in the UE's location determined by the multi-RTT method.

Considering this, the total absolute value of the UE Rx-Tx time difference should be reported to the network, specifically to the LMF, to ensure measurement precision.

3GPP TS 38.133 for Rel-18, in Section 10.1.25.3.1, outlines the procedure for absolute UE Rx-Tx time difference report mapping based on terrestrial networks, where it is reasonable to assume a fixed DL subframe duration due to stationary gNBs. In this terrestrial context, the reporting range for absolute UE Rx-Tx time difference measurement spans from −985024*T_{c} to 985024*T_{c}, with a resolution step of 2^{k}*T_{c} (where T_{c} is the transmission time interval, and k varies between 0 and 5, determined by whether measurements are taken in frequency range 1 (FR1) or frequency range 2 (FR2)). This implies that the reported UE Rx-Tx time difference value lies between approximately −0.5 ms and +0.5 ms with varying resolution steps. The calculation of the additional component of the UE Rx-Tx time difference is delegated to the LMF, which knows the indices of the subframes where the PRS and SRS are received and transmitted by the UE, allowing for a total UE Rx-Tx time difference to be computed under the assumption of constant subframe duration in terrestrial networks.

In NTN scenarios, on the other hand, such assumptions are not valid due to the variability in subframe duration caused by the satellite's relatively high velocity. Thus, the UE must report the total absolute value of the UE Rx-Tx time difference. To accommodate this, an extension of the reporting range for the absolute UE Rx-Tx time difference measurement should be used, covering only positive values. If the range were expanded to cover from 0 to 2²⁹*T_{c}, the reporting capability could support up to 273 ms for the absolute UE Rx-Tx time difference measurement. This extension would sufficiently account for the distance variations between receiving PRS and transmitting SRS without the need to adjust the existing resolution step of 2^{k}*T_{c}.

The above analysis of the LEO-600 scenario demonstrates that, due to the satellite's high speed, the length of the DL subframe as perceived by the UE can vary by as much as +/−48 ns. When considering UL subframes, the situation can become more complex.

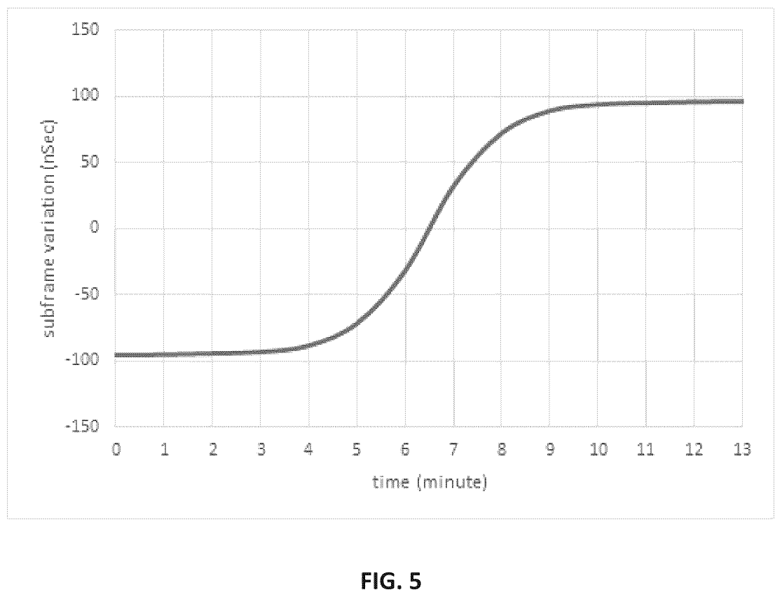

FIG. 5 is a chart depicting UL subframe variation over time, according to an embodiment.

Referring to FIG. 5, since the UE compensates for timing based on the DL signal it receives, the UL subframe timing, as observed by the gNB, may undergo changes up to twice that observed in the DL subframe, which means variations could be up to 96 ns. This phenomenon is depicted by the chart illustrated in FIG. 5, which shows the amount of UL subframe shrinkage or expansion as the satellite's position relative to the UE changes in a transparent payload scenario.

However, there are factors to consider regarding the UE Rx-Tx time difference in this context.

As a first factor, the UE may autonomously adjust its timing advance (TA) and subframe timing, informed by its GNSS position and the satellite's ephemeris. This autonomy may be used to maintain the UE's synchronicity with the satellite's timing.

As a second factor, TA commands (TACs) may be issued by the gNB when it detects that the UE's timing is drifting and falling out of sync.

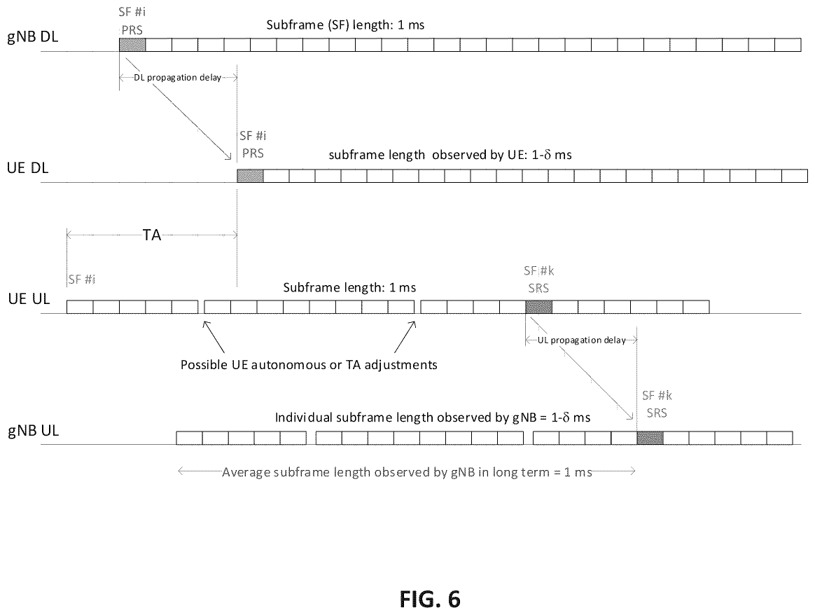

FIG. 6 illustrates a timing diagram comparing gNB DL and UL subframes to UE DL and UL subframes, according to an embodiment.

Referring to FIG. 6, the timing diagram reflects a scenario in which a satellite is getting closer to a UE. As illustrated therein, the UE observes that a length of a received DL subframe is shortened by δ ms.

For a UL transmission, without loss of generality, it is assumed that the UE does not pre-compensate the length of the UL subframes for the observed Doppler. The uplink frame transmission takes place at a TA as calculated using Equation (2), before the reception of the first detected path (in time) of the corresponding downlink frame from the reference cell.

$$T A = ( {N}_{TA} + {N}_{TA - offset} + {N}_{TA , adj}^{14 ommon} + {N}_{TA , adj}^{UE} ) \times {T}_{c} \qquad ( 2 )$$

The UE may keep updating N_{TA,adj}^{UE}, according to the UE's mobility and the trajectory of the satellite.

It is also possible that the UE receives a TAC from the network to update N_{TA}.

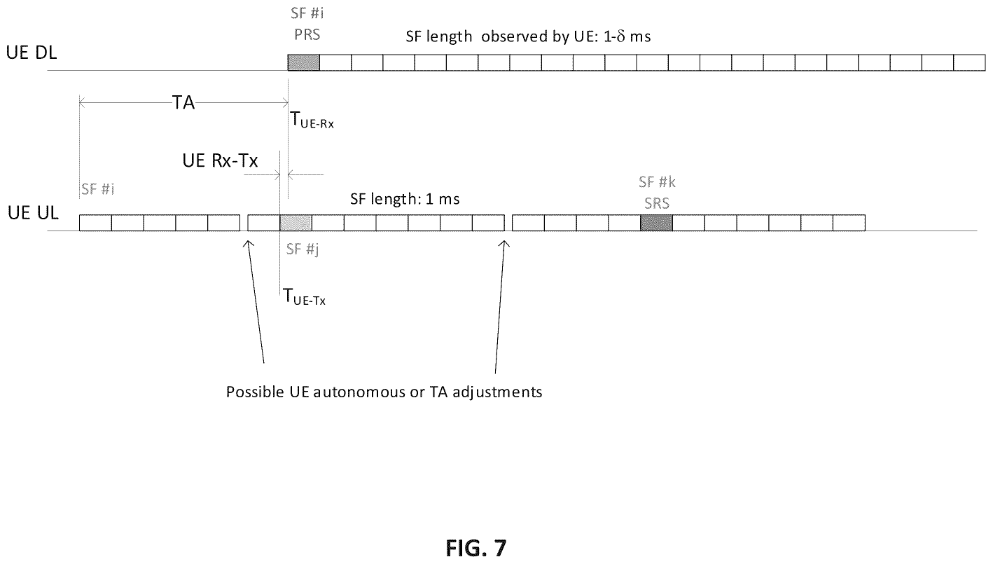

FIG. 7 illustrates a UE Rx-Tx time difference, according to an embodiment. More specifically, FIG. 7 illustrates an example of how UE Rx-Tx measurement is performed at a UE.

Referring to FIG. 7, a gNB is configured, by an LMF, to transmit a PRS (or a CSI-RS) to a target UE. Moreover, the target UE is configured, by the LMF, to transmit an SRS to the gNB. The SRS transmission should happen within a certain range from reception of the PRS by the UE. For example, SRS transmission should happen within +/−20 ms from reception of the PRS. This helps to avoid any timing drift due to UE clock drift and/or subframe timing shrinkage/expansion due to Doppler as explained above.

The UE then measures a UE Rx-Tx time difference, which may be defined as T_{UE-Rx}−T_{UE-Tx} as illustrated in FIG. 7.

Here, T_{UE-Rx} is the UE received timing of DL subframe #i from a transmission point (TP), defined by the first detected path of DL subframe #i in time. T_{UE-Tx} is the UE transmit timing of UL subframe #j that is closest in time to the DL subframe #i received from the TP.

Multiple PRSs or CSI-RSs for tracking resources, e.g., as instructed by the network higher layers or an LMF, can be used to determine the start of one subframe of the first arrival path of the TP.

The UE then reports the measured UE Rx-Tx to the network higher layers or LMF.

Although FIG. 7 illustrates an example in which the value of UE Rx-Tx is positive, the value of UE Rx-Tx may be either negative or positive. For example, depending on the value of TA applied to the UL transmission, if UL subframe #j happens after DL subframe #i, then the value of UE Rx-Tx would be negative.

In addition to UE Rx-Tx, the UE may report, to the network higher layers or LMF, at least one of 1) subframe indices #j and #k, where subframe #k is the subframe in which the UE transmits the SRS to the gNB, or 2) an offset value that indicates a time offset between the UE transmit timing of UL subframe #j and the UE transmit timing of UL subframe #k, as is illustrated in FIG. 7.

For the network or LMF to be able to accurately calculate an effective amount of time difference between receiving a PRS by the UE and transmitting an SRS by the same UE, auxiliary reports including various adjustment information may be sent to the network higher layers or LMF by the UE.

Hereinbelow, various examples of auxiliary reports are provided.

### Time Based Auxiliary Reports

### Time Based Option 1:

According to an embodiment, a UE reports, to an LMF, a total aggregate value of all TA adjustments that the UE has applied to TA between receiving a PRS (or a CSI-RS) in DL subframe #i (or UL subframe #j) and transmitting an SRS in UL subframe #k. The UE may add all autonomous timing adjustments (N_{TA,adj}^{UE}) as well as all N_{TA} adjustments. These values may be positive or negative, and the aggregate value may also be positive or negative.

The UE then reports the aggregate value to the LMF. The UE also reports UE Rx-Tx and an offset value as described above.

For example, the UE may report the aggregate value of all timing adjustments, which is denoted as N_{TA,adj}^{total}, as shown in Equation (3).

$${N}_{TA , adj}^{total} = {\sum }_{UL SF \# j}^{UL SF \# k} ( {N}_{TA} + {N}_{TA , adj}^{UE} ) \qquad ( 3 )$$

### Time Based Option 2:

According to an embodiment, a UE reports, to an LMF, a total aggregate value of all TA adjustments that the UE has applied to TA between TA seconds before receiving a PRS (or a CSI-RS) in a DL channel, i.e., equivalently at UL subframe #i, and transmitting an SRS in UL subframe #k. The UE may add all autonomous timing adjustments (N_{TA,adj}^{UE}) as well as all N_{TA} adjustments. These values may be positive or negative, and the aggregate value may also be positive or negative.

The UE then reports the aggregate value to the LMF. The UE also reports UE Rx-Tx and an offset value as explained above.

For example, the UE may report the aggregate value of all timing adjustments, which is denoted as N_{TA,adj}^{total}, as shown in Equation (4).

$${N}_{TA , adj}^{total} = {\sum }_{UL SF \# i}^{UL SF \# k} ( {N}_{TA} + {N}_{TA , adj}^{UE} ) \qquad ( 4 )$$

For Time Base Options 1 and 2, new signaling may be defined to report the aggregate TA value. According to an embodiment, a medium access control (MAC) control element (CE) similar to the one used to report TA commands may be defined with a longer bit field to report the aggregate TA value. The UE may report the aggregated TA via the MAC CE, and the gNB would send it to the LMF via LTE positioning protocol (LPP) signaling.

Alternatively, RRC signaling may be used instead of the MAC CE. However, if RRC signaling is used, the LMF may have to somewhat compensate for satellite motion.

### Doppler Based Auxiliary Reports

### Doppler Based Option 1:

According to an embodiment, a UE may report, to an LMF, a difference between a

Doppler frequency measured when receiving a PRS (or a CSI-RS) in DL subframe #i (or UL subframe #j) and a Doppler frequency measured when transmitting an SRS in UL subframe #k. The UE may calculate the Doppler frequency at DL subframe #i, when it receives the PRS (or the CSI-RS) and also at UL subframe #k when it transmits the SRS.

Thereafter, the difference between the two values may be reported to the LMF. The reported value may be positive or negative, depending whether the Doppler is increasing or decreasing while the PRS is received and the SRS is sent.

The UE may also report UE Rx-Tx and an offset value as explained above.

The UE may also report the Doppler frequency measured at DL subframe #i or at UL subframe #k, separately, to the LMF.

For example, the UE may report the differential value of the Doppler frequency, e.g., in parts per million (ppm), denoted as ΔF_{d}, as shown in Equation (5).

$$Δ {F}_{d} = {F}_{d} ( UL SF \# k ) - {F}_{d} ( UL SF \# j ) \qquad ( 5 )$$

In Equation (5), F_{d}(UL SF #k) and F_{d}(UL SF #j) represent Doppler frequency measured by the UE at UL subframes #k and #j, respectively.

### Doppler Based Option 2:

According to an embodiment, a UE may report, to an LMF, a difference between a Doppler frequency measured at TA seconds before receiving a PRS (or a CSI-RS) in DL channel, i.e., equivalently at UL subframe #i, and a Doppler frequency measured when transmitting an SRS in UL subframe #k. The UE may calculate the Doppler frequency TA seconds before it receives the PRS (or the CSI-RS) and when it transmits the SRS.

Thereafter, the difference between the two values are reported to the LMF. The reported value may be positive or negative, depending whether the Doppler frequency is increasing or decreasing while the PRS is received and the SRS is sent.

The UE may also report UE Rx-Tx and an offset value as explained above.

The UE may also report the Doppler frequency measured at UL subframe #i or at UL subframe #k, separately, to the LMF.

For example, the UE may report the differential value of the Doppler frequency, denoted as ΔF_{d}, as shown in Equation (6).

$$Δ {F}_{d} = {F}_{d} ( UL SF \# k ) - {F}_{d} ( UL SF \# i ) \qquad ( 6 )$$

In Equation (6), F_{d}(UL SF #k) and F_{d}(UL SF #i) represent Doppler frequency measured by the UE at UL subframes #k and #i, respectively.

For Doppler Based Options 1 and 2, in addition to the usual measurements for positioning, a positioning report includes reporting Doppler values or a differential Doppler frequency value.

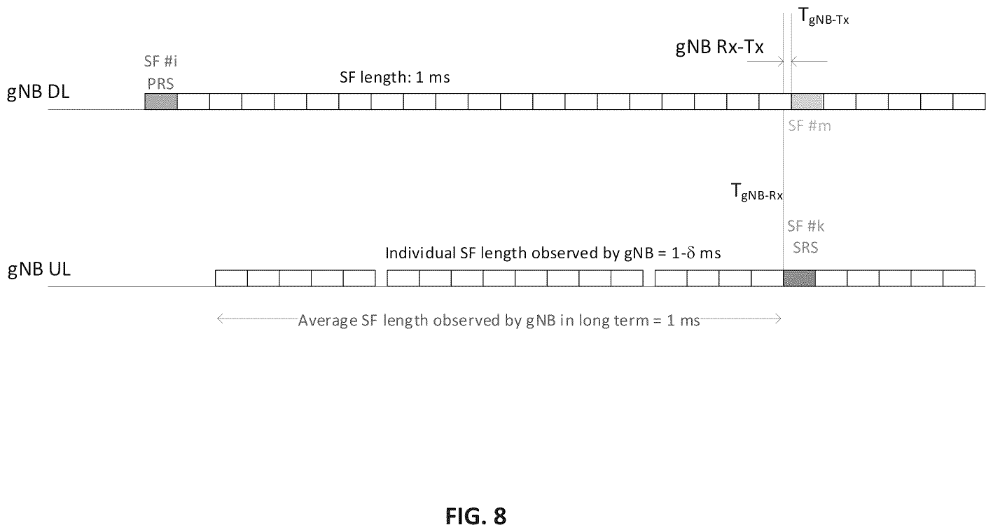

FIG. 8 illustrates a gNB Rx-Tx time difference, according to an embodiment. More specifically, FIG. 8 illustrates an example of how gNB Rx-Tx measurement is performed at a gNB.

Referring to FIG. 8, a gNB is configured, by an LMF, to transmit a PRS (or a CSI-RS) to a target UE. The target UE is also configured, by the LMF, to transmit an SRS to the gNB. The gNB Rx-Tx time difference may be defined as T_{gNB-Rx}−T_{gNB-Tx}, as shown in FIG. 8.

T_{gNB-Rx} is the gNB received timing of UL subframe #k including an SRS associated with the UE, defined by the first detected path in time, and T_{gNB-Tx} is the gNB transmit timing of DL subframe #m that is closest in time to the subframe #k received from the UE.

Multiple SRS resources can be used to determine the start of one subframe including the SRS.

The gNB reports the Rx-Tx time difference to the LMF. Similar to when the UE reports a UE Rx-Tx time difference, new fields may be added, such as a Doppler frequency differential, be defined to report the Rx-Tx time difference.

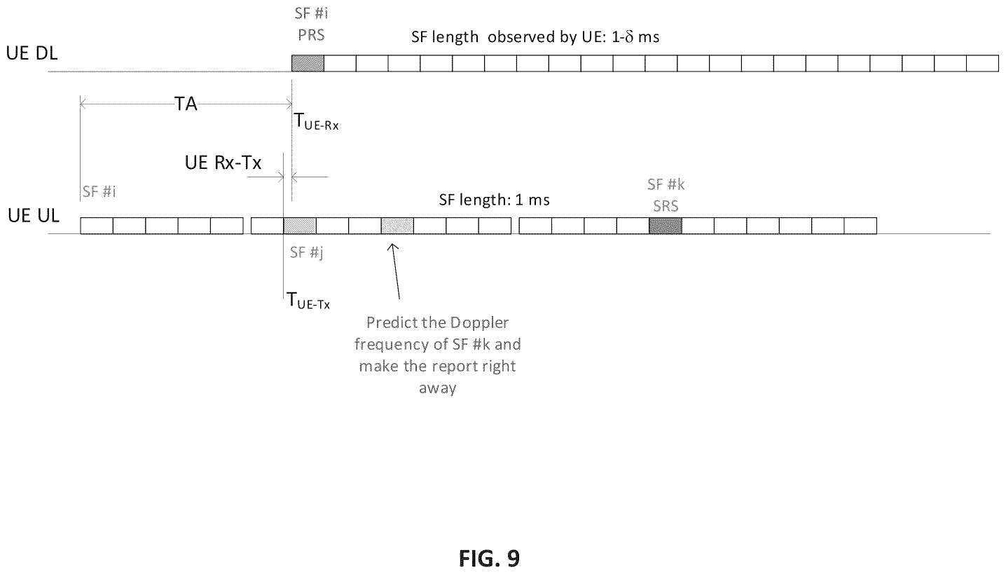

FIG. 9 illustrates an example of UE reporting using predicted Doppler, according to an embodiment. More specifically, FIG. 9 illustrates a UE predicting a Doppler frequency at UL subframe #k, right after subframe #j.

Referring to FIG. 9, after a UE receives ephemeris information of a satellite (and the neighboring satellites) in the system information from the network, the UE will be able to accurately predict the satellite (or satellites) trajectory for an adequate amount of time, e.g., 10 seconds, in the future.

According to an embodiment, based on the ephemeris and the predicted trajectory of the satellite, the UE predicts the Doppler frequency at UL subframe #k, well in advance. Since the measurement for UE Rx-Tx is already ready at UL subframe #j, the UE is able to report UE Rx-Tx and the differential Doppler frequency value according to Doppler Based Option 1 or 2, as described above, relatively quickly after UL subframe #j. Although FIG. 9 illustrates the prediction and report occurring 3 subframes after subframe #j, the disclosure is not limited thereto.

Although 3GPP Rel-17 requires a UE to transmit an SRS for UE Rx-Tx measurement within at most +/−160 ms of receiving a DL PRS (or a CSI-RS) by the UE, for NTN scenarios such as LEO, where a satellite often moves at a relatively high speed, the UE may observe Doppler frequency as high as 48 KHz. Therefore, according to an embodiment, the +/−160 ms requirement may be lowered for NTN scenarios. For example, lower values in the range of +/−10 ms to +/−20 ms are more appropriate for NTN scenarios.

As described above, wherever applicable, multiple SRS may be transmitted by a UE to improve accuracy of measurements. Generally, there are three options for how the UE reports the auxiliary information for multiple SRS.
1. Individual reporting: The UE reports auxiliary information separately for each SRS transmission, where applicable.
2. Selective reporting: The UE reports auxiliary information only for one SRS arbitrarily, and an LMF assumes that this one auxiliary report is valid for all individual SRS transmissions.
3. Average reporting: The UE calculates an average value of the adjustment information for the auxiliary report of all SRS transmissions and reports the average value to LMF.

For Selective reporting and Selective reporting, new measurement may be defined for the selecting and/or the averaging, although this may be left up to the network. In addition, a gNB may signal which SRSs are jointly sent and can be jointly processed (e.g., definition of a “train” of SRS).

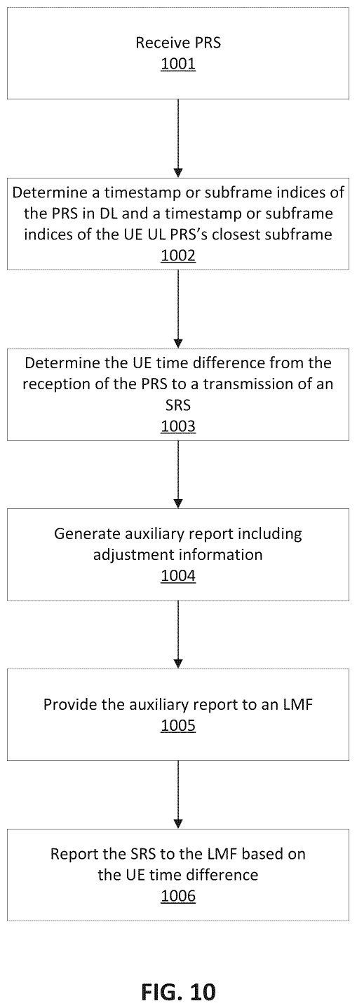

FIG. 10 is a flowchart illustrating a method performed by a UE in an NTN environment, according to an embodiment.

Referring to FIG. 10, in step 1001, a PRS is received by the UE. The PRS may be received in DL from a base station. For example, as illustrated in FIG. 7, the PRS is received in subframe #i.

In step 1002, a timestamp or subframe indices of the PRS in DL are determined, and a timestamp or subframe indices of the UE UL PRS's closest subframe are determined. For example, as illustrated in FIG. 7, a timestamp or subframe indices of the PRS in DL subframe #i are determined, and a timestamp or subframe indices of UL subframe #j are determined.

In step 1003, a UE time difference may be determined from the reception of the PRS to a transmission of an SRS based on the timestamps or subframe indices.

In step 1004, the UE generates an auxiliary report including adjustment information for an LMF to calculate the UE time difference. For example, the auxiliary report may generated according to Time Based Option 1, Time Based Option 2, Doppler Based Option 1, or Doppler Based Option 2 as described above.

In step 1005, the UE provides the auxiliary report to the LMF, e.g., via a MAC CE.

In step 1006, the SRS is reported to the LMF based on the UE time difference. As noted above, the LMF may be structurally implemented by a network node, terminal, UE, satellite, base station, or any other device connected to the network.

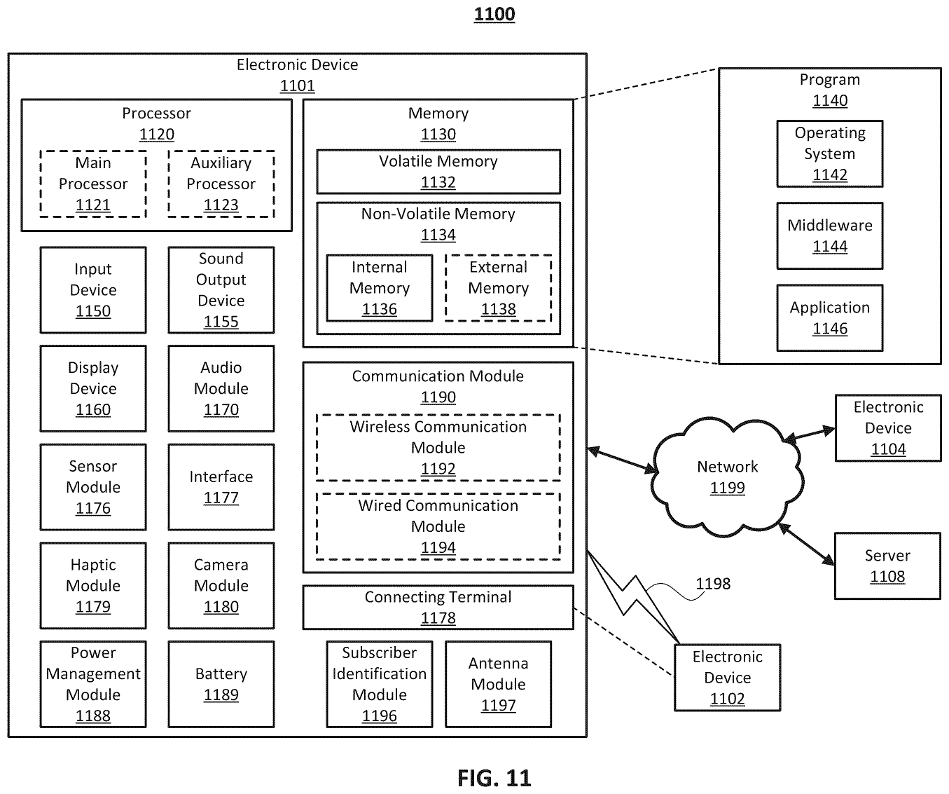

FIG. 11 is a block diagram of an electronic device in a network environment 1100, according to an embodiment. For example, the electronic device 1101 of FIG. 11 may correspond to one or more of the UE 101, satellite 102, and/or gNB 103 illustrated in FIG. 1. One or more of the components shown in the electronic device 1101 may be included in one or more of the UE 101, satellite 102, and/or gNB 103.

Referring to FIG. 11, an electronic device 1101 in a network environment 1100 may communicate with an electronic device 1102 via a first network 1198 (e.g., a short-range wireless communication network), or an electronic device 1104 or a server 1108 via a second network 1199 (e.g., a long-range wireless communication network). The electronic device 1101 may communicate with the electronic device 1104 via the server 1108. The electronic device 1101 may include a processor 1120, a memory 1130, an input device 1150, a sound output device 1155, a display device 1160, an audio module 1170, a sensor module 1176, an interface 1177, a haptic module 1179, a camera module 1180, a power management module 1188, a battery 1189, a communication module 1190, a subscriber identification module (SIM) card 1196, or an antenna module 1197. In one embodiment, at least one (e.g., the display device 1160 or the camera module 1180) of the components may be omitted from the electronic device 1101, or one or more other components may be added to the electronic device 1101. Some of the components may be implemented as a single integrated circuit (IC). For example, the sensor module 1176 (e.g., a fingerprint sensor, an iris sensor, or an illuminance sensor) may be embedded in the display device 1160 (e.g., a display).

The processor 1120 may execute software (e.g., a program 1140) to control at least one other component (e.g., a hardware or a software component) of the electronic device 1101 coupled with the processor 1120 and may perform various data processing or computations, e.g., the operations illustrated in FIG. 10.

As at least part of the data processing or computations, the processor 1120 may load a command or data received from another component (e.g., the sensor module 1176 or the communication module 1190) in volatile memory 1132, process the command or the data stored in the volatile memory 1132, and store resulting data in non-volatile memory 1134. The processor 1120 may include a main processor 1121 (e.g., a central processing unit (CPU) or an application processor (AP)), and an auxiliary processor 1123 (e.g., a graphics processing unit (GPU), an image signal processor (ISP), a sensor hub processor, or a communication processor (CP)) that is operable independently from, or in conjunction with, the main processor 1121. Additionally or alternatively, the auxiliary processor 1123 may be adapted to consume less power than the main processor 1121, or execute a particular function. The auxiliary processor 1123 may be implemented as being separate from, or a part of, the main processor 1121.

The auxiliary processor 1123 may control at least some of the functions or states related to at least one component (e.g., the display device 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). The auxiliary processor 1123 (e.g., an image signal processor or a communication processor) may be implemented as part of another component (e.g., the camera module 1180 or the communication module 1190) functionally related to the auxiliary processor 1123.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134. Non-volatile memory 1134 may include internal memory 1136 and/or external memory 1138.

The program 1140 may be stored in the memory 1130 as software, and may include, for example, an operating system (OS) 1142, middleware 1144, or an application 1146.

The input device 1150 may receive a command or data to be used by another component (e.g., the processor 1120) of the electronic device 1101, from the outside (e.g., a user) of the electronic device 1101. The input device 1150 may include, for example, a microphone, a mouse, or a keyboard.

The sound output device 1155 may output sound signals to the outside of the electronic device 1101. The sound output device 1155 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1160 may visually provide information to the outside (e.g., a user) of the electronic device 1101. The display device 1160 may include, for example, a display, a hologram device, or a projector and control circuitry to control a corresponding one of the display, hologram device, and projector. The display device 1160 may include touch circuitry adapted to detect a touch, or sensor circuitry (e.g., a pressure sensor) adapted to measure the intensity of force incurred by the touch.

The audio module 1170 may convert a sound into an electrical signal and vice versa. The audio module 1170 may obtain the sound via the input device 1150 or output the sound via the sound output device 1155 or a headphone of an external electronic device 1102 directly (e.g., wired) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device 1102 directly (e.g., wired) or wirelessly. The interface 1177 may include, for example, a high-definition multimedia interface (HDMI), a universal serial bus (USB) interface, a secure digital (SD) card interface, or an audio interface.

A connecting terminal 1178 may include a connector via which the electronic device 1101 may be physically connected with the external electronic device 1102. The connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via tactile sensation or kinesthetic sensation. The haptic module 1179 may include, for example, a motor, a piezoelectric element, or an electrical stimulator.

The camera module 1180 may capture a still image or moving images. The camera module 1180 may include one or more lenses, image sensors, image signal processors, or flashes. The power management module 1188 may manage power supplied to the electronic device 1101. The power management module 1188 may be implemented as at least part of, for example, a power management integrated circuit (PMIC).

The battery 1189 may supply power to at least one component of the electronic device 1101. The battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the AP) and supports a direct (e.g., wired) communication or a wireless communication. The communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as BLUETOOTH™, wireless-fidelity (Wi-Fi) direct, or a standard of the Infrared Data Association (IrDA)) or the second network 1199 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The antenna module 1197 may transmit or receive a signal or power to or from the outside (e.g., the external electronic device) of the electronic device 1101. The antenna module 1197 may include one or more antennas, and, therefrom, at least one antenna appropriate for a communication scheme used in the communication network, such as the first network 1198 or the second network 1199, may be selected, for example, by the communication module 1190 (e.g., the wireless communication module 1192). The signal or the power may then be transmitted or received between the communication module 1190 and the external electronic device via the selected at least one antenna.

Commands or data may be transmitted or received between the electronic device 1101 and the external electronic device 1104 via the server 1108 coupled with the second network 1199. Each of the electronic devices 1102 and 1104 may be a device of a same type as, or a different type, from the electronic device 1101. All or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1101. The electronic device 1101 may provide the outcome, with or without further processing of the outcome, as at least part of a reply to the request. To that end, a cloud computing, distributed computing, or client-server computing technology may be used, for example.

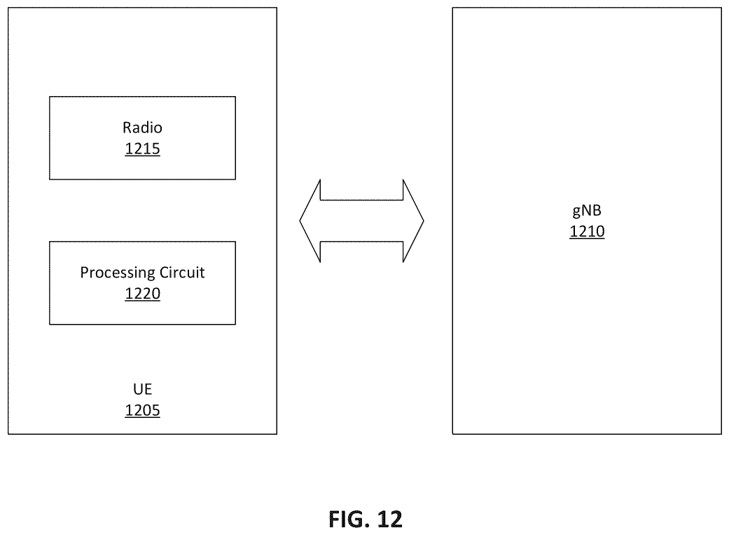

FIG. 12 shows a system including a UE 1205 and a gNB 1210, in communication with each other.

Referring to FIG. 12, the UE may include a radio 1215 and a processing circuit (or a means for processing) 1220, which may perform various methods disclosed herein, e.g., the method illustrated in FIG. 10. For example, the processing circuit 1220 may receive, via the radio 1215, transmissions from the network node (gNB) 1210, and the processing circuit 1220 may transmit, via the radio 1215, signals to the gNB 1210.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE) in a non-terrestrial network (NTN), the method comprising:
receiving, from a base station, a positioning reference signal (PRS) in a downlink (DL) subframe;
determining a timestamp or subframe indices of the PRS in the DL subframe and a timestamp or subframe indices of a UE uplink (UL) subframe that is closest in time to the DL subframe;
determining, based on the timestamps or the subframe indices, a UE time difference from receiving the PRS to a transmission of a sounding reference signal (SRS);
generating an auxiliary report including adjustment information for a location management function (LMF) to calculate the UE time difference;
providing the auxiliary report to the LMF; and
reporting, to the LMF, the SRS based on the UE time difference.

2. The method of claim 1, wherein the adjustment information includes a Doppler frequency measured when receiving the PRS and a Doppler frequency measured when transmitting the SRS.

3. The method of claim 1, wherein the adjustment information includes a differential value of Doppler frequency based on a difference between a Doppler frequency measured when receiving the PRS and a Doppler frequency measured when transmitting the SRS.

4. The method of claim 1, wherein the adjustment information includes a differential value of Doppler frequency based on a difference between a Doppler frequency measured a time point before receiving the PRS and a Doppler frequency measured when transmitting the SRS.

5. The method of claim 1, wherein a Doppler frequency measured a time point before receiving the PRS and a Doppler frequency measured when transmitting the SRS.

6. The method of claim 1, wherein the adjustment information includes an aggregate value of timing advance (TA) adjustments applied by the UE from a time point before receiving the PRS to a time point of the transmission of the SRS.

7. The method of claim 6, wherein the aggregate value of the TA adjustments includes autonomous adjustments or network-triggered adjustments.

8. The method of claim 1, wherein the adjustment information includes an aggregate value of timing advance (TA) adjustments applied by the UE from a time point at of receiving the PRS to a time point of the transmission of the SRS.

9. The method of claim 8, wherein the aggregate value of the TA adjustments includes autonomous adjustments or network-triggered adjustments.

10. The method of claim 1, further comprising reporting the UE time difference to the LMF.

11. The method of claim 10, further comprising reporting, to the LMF, at least one of the subframe indices of the UE UL subframe that is closest in time to the DL subframe and subframe indices of a subframe in which the UE transmits the SRS, or an offset value indicating a time offset between a UE transmit timing of the UE UL subframe that is closest in time to the DL subframe and a UE transmit timing of the subframe in which the UE transmits the SRS.

12. The method of claim 1, wherein providing the auxiliary report to the LMF comprise one of:
providing an individual auxiliary report for each SRS transmission;
providing a selective auxiliary report for one SRS, which is valid for all individual SRS transmissions; or
proving an average auxiliary report including an average value of the adjustment information for all SRS transmissions.

13. A user equipment (UE) for use in a non-terrestrial network (NTN), the UE comprising:
at least one processor; and
memory that stores instructions, which when executed by the at least one processor, controls the UE to:
receive, from a base station, a positioning reference signal (PRS) in a downlink (DL) subframe,
determine a timestamp or subframe indices of the PRS in the DL subframe and a timestamp or subframe indices of a UE uplink (UL) subframe that is closest in time to the DL subframe,
determine, based on the timestamps or the subframe indices, a UE time difference from receiving the PRS to a transmission of a sounding reference signal (SRS),
generate an auxiliary report including adjustment information for a location management function (LMF) to calculate the UE time difference,
provide the auxiliary report to the LMF, and
report, to the LMF, the SRS based on the UE time difference.

14. The UE of claim 13, wherein the adjustment information includes a Doppler frequency measured when receiving the PRS and a Doppler frequency measured when transmitting the SRS.

15. The UE of claim 13, wherein the adjustment information includes a differential value of Doppler frequency based on a difference between a Doppler frequency measured when receiving the PRS and a Doppler frequency measured when transmitting the SRS.

16. The UE of claim 13, wherein the adjustment information includes a differential value of Doppler frequency based on a difference between a Doppler frequency measured a time point before receiving the PRS and a Doppler frequency measured when transmitting the SRS.

17. The UE of claim 13, wherein a Doppler frequency measured a time point before receiving the PRS and a Doppler frequency measured when transmitting the SRS.

18. The UE of claim 13, wherein the adjustment information includes an aggregate value of timing advance (TA) adjustments applied by the UE from a time point before receiving the PRS to a time point of the transmission of the SRS.

19. The UE of claim 18, wherein the aggregate value of the TA adjustments includes autonomous adjustments or network-triggered adjustments.

20. The UE of claim 13, wherein the adjustment information includes an aggregate value of timing advance (TA) adjustments applied by the UE from a time point at of receiving the PRS to a time point of the transmission of the SRS.
